(19) United States
(12) Patent Application Publication
(10) Pub. No.: US 2005/0263665 A1
(43) Pub. Date: Dec. 1, 2005

(54) Assembled/linked locking apparatus

(76) Inventor: Kuo-Chan Weng, Tuku Chen (TW)

Correspondence Address: TROXELL LAW OFFICE PLLC, SUITE 1404, 5205 LEESBURG PIKE, FALLS CHURCH, VA, 22041, US

(21) Appl. No.: 11/120,968

(22) Filed: May 4, 2005

(30) Foreign Application Priority Data
May 28, 2004 (TW) 093208498

(51) Int. Cl. F16M 13/00

(52) U.S. Cl. 248/429

(57) ABSTRACT

An assembled/linked locking apparatus including a first and a second slide rail assemblies and a first and a second activators. The first and second slide rail assemblies respectively include a stationary slide rail and a telescopic slide rail set. The first activator is disposed at an end of the telescopic slide rail set. The second activator is corresponding to the first activator and disposed at the stationary slide rail. The second activator includes a base seat, a guide seat, a bar member, a pair of slide ways and a slide member. The base seat is disposed at the stationary slide rail. The guide seat is disposed on the base seat. The two slide ways are oppositely respectively formed on the base seat and the guide seat. Two ends of the slide member are respectively fitted in the slide ways. Two ends of the bar member are respectively passed through the spaces between the base seats and the guide seats of the first and second slide rail assemblies. When the telescopic slide rail set of the second slide rail assembly extends out of the stationary slide rail, the first activator drags the slide member to push and engage with the bar member so as to prevent the telescopic slide rail set of the first slide rail assembly from extending out of the stationary slide rail.

### BACKGROUND OF THE INVENTION

The present invention is related to a locking apparatus, and more particularly to an assembled/linked locking apparatus of a tool cabinet or file cabinet having several drawers.

A drawer and a cabinet are equipped with corresponding rails. The rails are slidably fitted with each other for easily pushing or drawing the drawer within the cabinet. The rails are provided with stoppers such as projecting blocks or projecting plates to prevent the drawer from detaching from the cabinet and dropping.

The drawer is often designed with a considerable length for receiving more articles. In order to fully draw the drawer out of the cabinet without being derailed and immediately push the drawer into the cabinet after taking articles, three rails are provided, including a cabinet slide rail, a middle slide rail and a drawer slide rail. Each slide rail has stop blocks on predetermined portions of one end or two ends of the slide rail. The slide rails are slidably assembled with each other and the stop blocks stop each other, whereby the drawer can be fully drawn out of the cabinet without derailing and dropping. Ball bearings are provided between the slide rails to reduce frictional force therebetween and noise.

The tool cabinet or file cabinet includes several drawers arranged from upper side to lower side. After the drawers contain tools or files, the drawers will have considerable weight. In the case that the drawers are drawn too hard or in the case of earthquake or collision by external force, the tool cabinet or file cabinet will be tilted to make some drawers slip out. Under such circumstance, the gravity center of the cabinet will change and the cabinet may fall down.

In order to avoid tilting down of the cabinet when drawing out too many drawers, a slide rail locking structure has been developed by which only one drawer can be drawn at one time. Substantially, a linking unit is disposed at one end of each slide rail assembly. Once the drawer slide rail of one slide rail assembly is pulled, the linking unit is activated to drive a link disposed between the respective slide rail assemblies to stop the drawer slide rails of other slider rail assemblies from being pulled. For example, in U.S. Pat. No. 5,352,030, a disc-like activating block is disposed at rear end of the drawer slide rail. In U.S. Pat. No. 5,634,701, an activating block having a slope is disposed at front end of one side of the drawer. In U.S. Pat. No. 5,988,778, an activating block is disposed at front end of the drawer slide rail.

In U.S. Pat. No. 5,352,030, a hook body is disposed at rear end of the drawer slide rail for hooking and pulling the disc-like activating block. This is strength-consuming and the components are likely to be worn. Therefore, the using life of the product is shortened.

### SUMMARY OF THE INVENTION

It is therefore a primary object of the present invention to provide an assembled/linked locking apparatus which can prolong the using life of the product without affecting the mobility of the drawers.

It is a further object of the present invention to provide the above assembled/linked locking apparatus which can be mounted in a narrow space of the slide rail assembly to more truly achieve the locking effect. When one of the drawers is drawn out, the other drawers are prevented from being drawn out.

According to the above objects, the assembled/linked locking apparatus of the present invention includes a first and a second slide rail assemblies and a first and a second activators. The first and second slide rail assemblies respectively include a stationary slide rail and a telescopic slide rail set. The first activator is disposed at the telescopic slide rail set. The second activator is disposed at the stationary slide rail. The second activator includes a base seat, a guide seat, a bar member, a pair of slide ways and a slide member.

The present invention can be best understood through the following description and accompanying drawings wherein:

### BRIEF DESCRIPTION OF THE DRAWINGS

FIG. 1 is a perspective exploded view of for one of slide rail assemblies of a first preferred embodiment of the present invention;

FIGS. 2A and 3A show the operation of the first embodiment of the present invention, wherein a third connecting section of a slide member is not shown;

FIGS. 2B and 3B are views respectively according to FIGS. 2A and 3A, showing that a bar member is displaced;

FIG. 4A to 4C are side views of the first embodiment of the present invention showing that when one of the drawers is drawn out, a first activator drags the slide member from a first position to a second position;

FIG. 5A to 5C are side views of the first embodiment of the present invention showing that when the drawer is pushed in, the first activator drags the slide member from the second position to the first position;

FIG. 6 is a perspective exploded view for one of slide rail assemblies of a second preferred embodiment of the present invention;

FIG. 7A is a perspective view of the second preferred embodiment of the present invention that a telescopic slide rail set is not wholly pushed into a stationary slide rail;

FIG. 7B is a perspective view of the second preferred embodiment of the present invention showing that a slide member of FIG. 7A is in the second position;

FIG. 8A is a perspective view of the second preferred embodiment of the present invention that the telescopic slide rail set is wholly pushed into the stationary slide rail;

FIG. 8B is a perspective view of the second preferred embodiment of the present invention showing that the slide member of FIG. 7A is in the first position;

FIG. 9 is a perspective exploded view for one of slide rail assemblies of a third preferred embodiment of the present invention;

FIG. 10A is a perspective view of the third preferred embodiment of the present invention that the telescopic slide rail set is not pulled out the stationary slide rail;

FIG. 10B is a perspective view of the third preferred embodiment of the present invention showing that the slide member of FIG. 10A is in the first position;

FIG. 11A is a perspective view of the third preferred embodiment of the present invention that the telescopic slide rail set is pulled out the stationary slide rail;

FIG. 11B is a perspective view of the third preferred embodiment of the present invention showing that the slide member of FIG. 11A is in the second position;

FIG. 12 is a perspective exploded view for one of slide rail assemblies of a fourth preferred embodiment of the present invention;

FIG. 13A is a perspective view of the fourth preferred embodiment of the present invention that the telescopic slide rail set is not wholly pushed into the stationary slide rail;

FIG. 13B is a perspective view of the fourth preferred embodiment of the present invention showing that the slide member of FIG. 13A is in the second position;

FIG. 14A is a perspective view of the fourth preferred embodiment of the present invention that the telescopic slide rail set is wholly pushed into the stationary slide rail; and

FIG. 14B is a perspective view of the fourth preferred embodiment of the present invention showing that the slide member of FIG. 14A is in the first position.

### DETAILED DESCRIPTION OF THE PREFERRED EMBODIMENTS

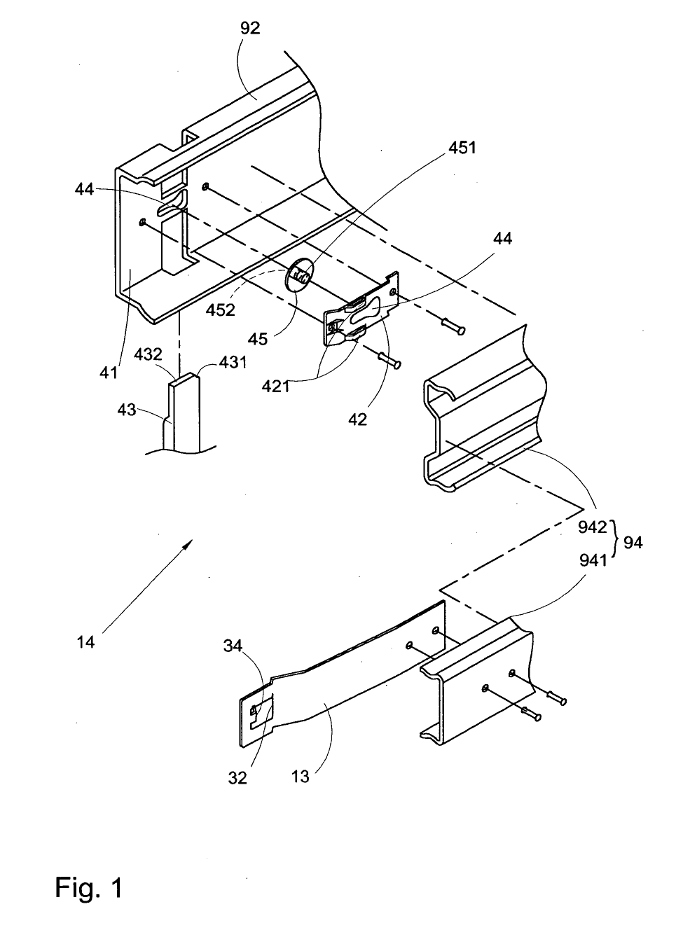

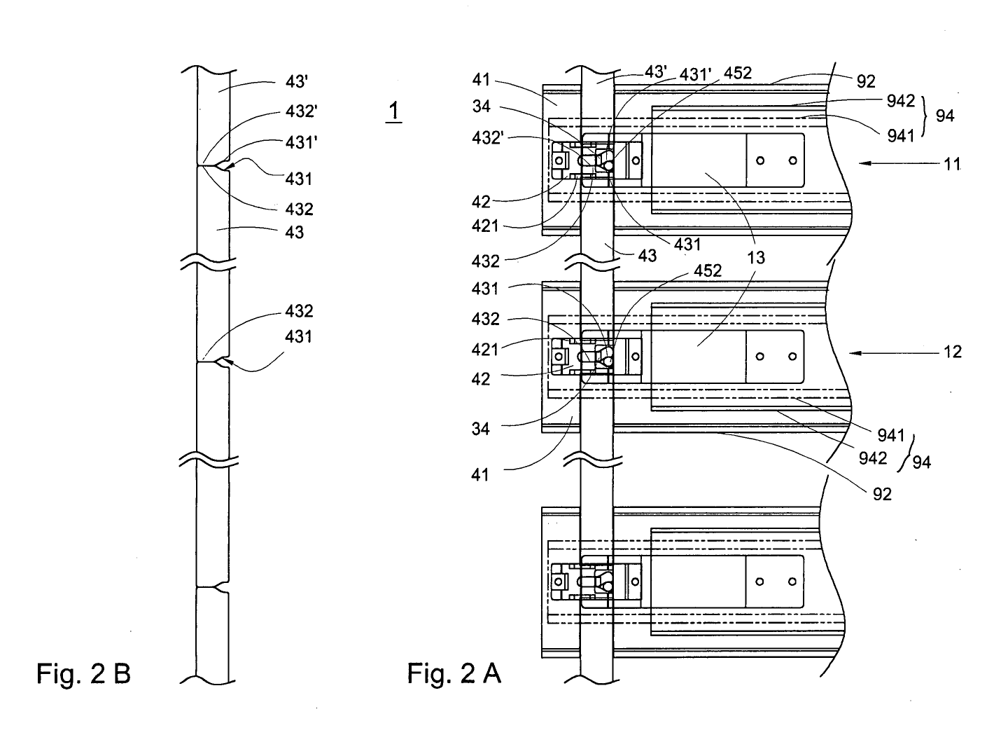

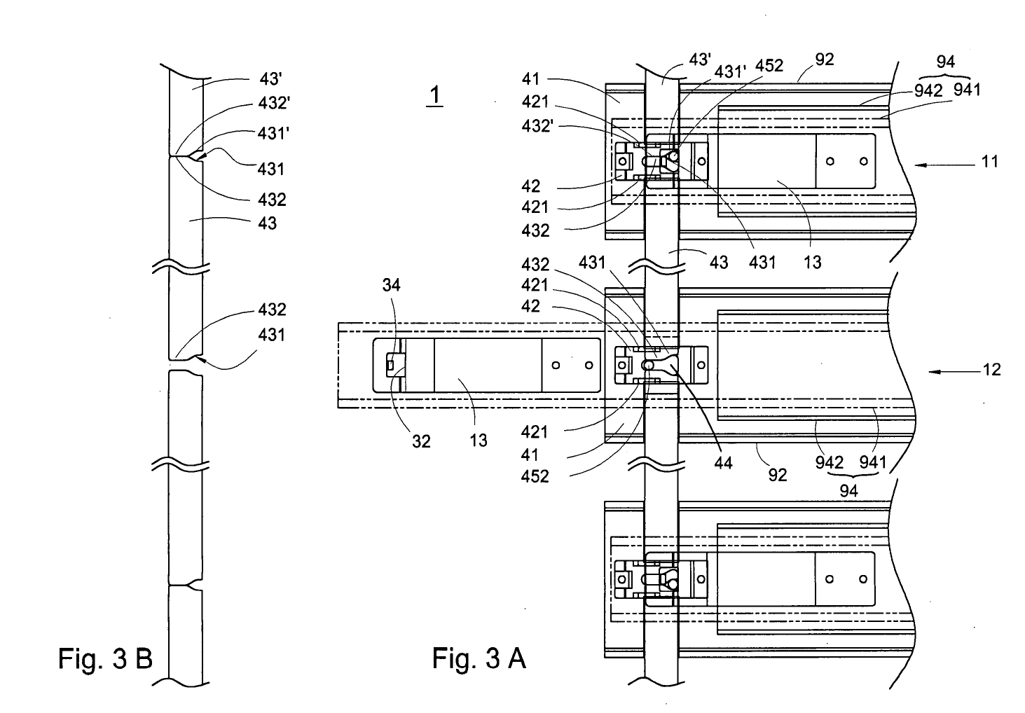

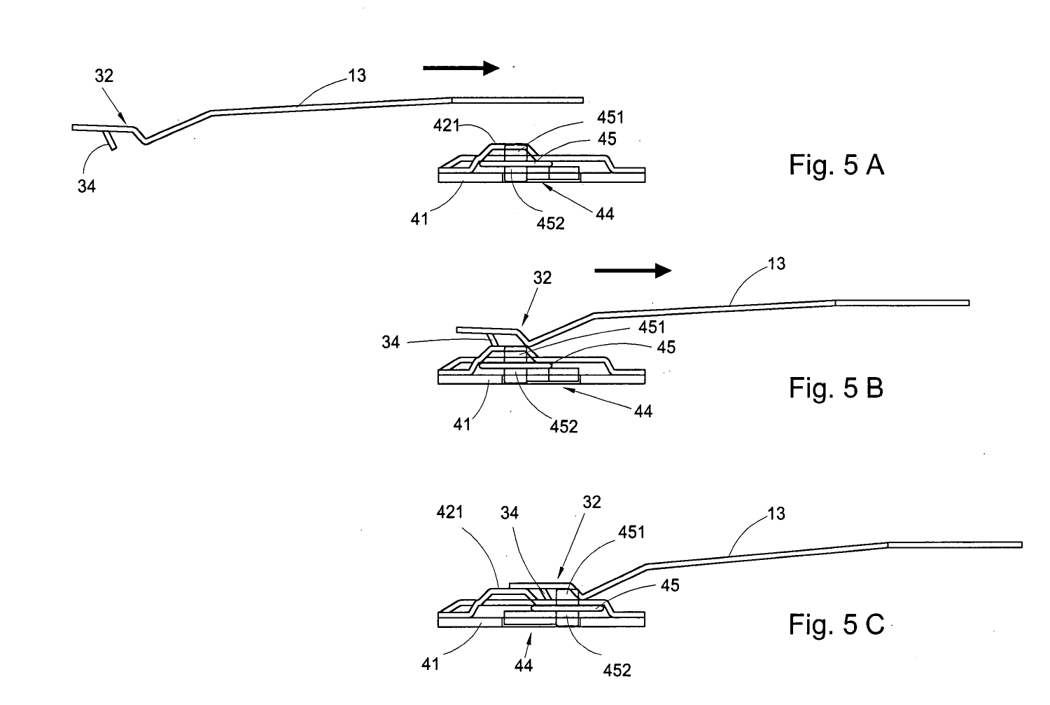

Please refer to FIGS. 1, 2A, 2B, 3A, 3B, 4A to 4C and 5A to 5C. The assembled/linked locking apparatus 1 of the present invention includes a first slide rail assembly 11, a second slide rail assembly 12, a first activator 13 disposed on the first and second slide rail assemblies 11, 12 and a second activator 14 disposed on the first and second slide rail assemblies 11, 12.

The first slide rail assembly 11 is positioned above the second slide rail assembly 12 corresponding to the second slide rail assembly 12. The first slide rail assembly 11 and the second slide rail assembly 12 respectively include a stationary slide rail 92 and a telescopic slide rail set 94.

The stationary slide rail 92 is a channeled body having a bottom wall and two sidewalls. An outer side of the bottom wall is fixed on inner side of a cabinet body having an internal space. At least two drawers are respectively corresponding to the first and second slide assemblies 11, 12 and vertically arranged in the internal space.

The telescopic slide rail set 94 includes a drawer slide rail 941 and a middle slide rail 942. The drawer slide rail 941 and the middle slide rail 942 are a channeled body having a bottom wall and two sidewalls. An outer side of the bottom wall of the drawer slide rail 941 is fixed on the corresponding drawer. The two sidewalls of the drawer slide rail 941 are slidably disposed in the middle slide rail 942. Via the middle slide rail 942, the telescopic slide rail set 94 is slidably disposed in the stationary slide rail 92. The telescopic slide rail set 94 can be extended out of front end of the stationary slide rail 92.

The first activator 13 is a plate body with a certain length. One end of the first activator 13 is disposed at an end of the telescopic slide rail set 94 such as front end of the drawer slide rail 941. The other end of the first activator 13 is formed with a first connecting section 32 which can be a cross section and a second connecting section 34 which can be a lug.

The second activator 14 is corresponding to the first activator 13 and disposed at the stationary slide rail 92. The second activator 14 includes a base seat 41, a guide seat 42, a bar member 43, a pair of slide ways 44 and a slide member 45.

The base seat 41 is disposed at the stationary slide rail 92.

The guide seat 42 is disposed on the base seat 41 corresponding to the first activator 13. The guide seat 42 has a guide face 421 for guiding the other end of the first activator 13 to swing. The effect of the guide face 421 will be described hereinafter.

The bar member 43 is reciprocally movably disposed between the first and second slide rail assemblies 11, 12. Two ends of the bar member 43 are respectively passed through the spaces between the base seats 41 and the guide seats 42 of the first and second slide rail assemblies 11, 12.

The two slide ways 44 are oppositely respectively formed on the base seat 41 and the guide seat 42. Each slide way 44 is a perforation having a two-stage shape similar to the shape of a saddle.

Two ends of the slide member 45 are respectively fitted through each slide way 44, whereby the slide member 45 can reciprocally move along the slide ways 44. A boss-shaped third connecting section 451 is formed on one face of the slide member 45. The third connecting section 451 is dragged by the first and second connecting sections 32, 34 of the first activator 13, whereby the slide member 45 can be back and forth reciprocally slid between a first position and a second position. A boss-shaped fourth connecting section 452 is formed on the other face of the slide member 45 opposite to the third connecting section 451 corresponding to an end of the bar member 43. A narrower space of the slide way 44 serves to restrict the slide member 45 from vertically moving. A larger space of the slide way 44 permits the slide member 45 to vertically move.

Each end of the bar member 43 is formed with a fifth connecting section 431 corresponding to the fourth connecting section 452. When the slide member 45 is positioned in the first position, the fourth and fifth connecting sections 452, 431 serve to abut against and push each other. The fifth connecting section 431 can be a notched shape.

Each end of the bar member 43 is formed with a sixth connecting section 432 corresponding to the fourth connecting section 452. When the slide member 45 is positioned in the second position, the fourth connecting section 452 abuts against the sixth connecting section 432. The sixth connecting section 432 can be a straight cross section.

When the slide members 45 of the first and second slide rail assemblies 11, 12 are positioned in the first position, that is, in the larger space of the slide way 44, any slide member 45 can be vertically moved within the corresponding slide way 44. When one of the slide members 45 is positioned in the second position, that is, in the narrower space of the slide way 44, the other slide member 45 cannot be vertically moved within the corresponding slide way 44. Accordingly, when one of the drawer slide rails 941 is extended, the first activator 13 drags the slide member 45 from the first position to the second position. At this time, the slide member 45 pushes the bar member 43 and then the slide member 45 is engaged with the bar member 43 to prevent the bar member 43 from moving.

According to the above arrangement, when the telescopic slide rail set 94 of the second slide rail assembly 12 is extended from the front end of the stationary slide rail 92, the first connecting section 32 of the first activator 13 drags the third connecting section 451 to make the slide member 45 move from the first position to the second position where the slide member 45 cannot vertically move within the slide way 44. Correspondingly, via the fourth connecting section 452, the slide member 45 pushes the bar member 43, whereby the fourth connecting section 452 of the slide member 45 abuts against the sixth connecting section 432 of the bar member 43 to engage with the bar member 43. Therefore, the telescopic slide rail set 94 of the first slide rail assembly 11 is prevented from being extended from the front end of the stationary slide rail 92.

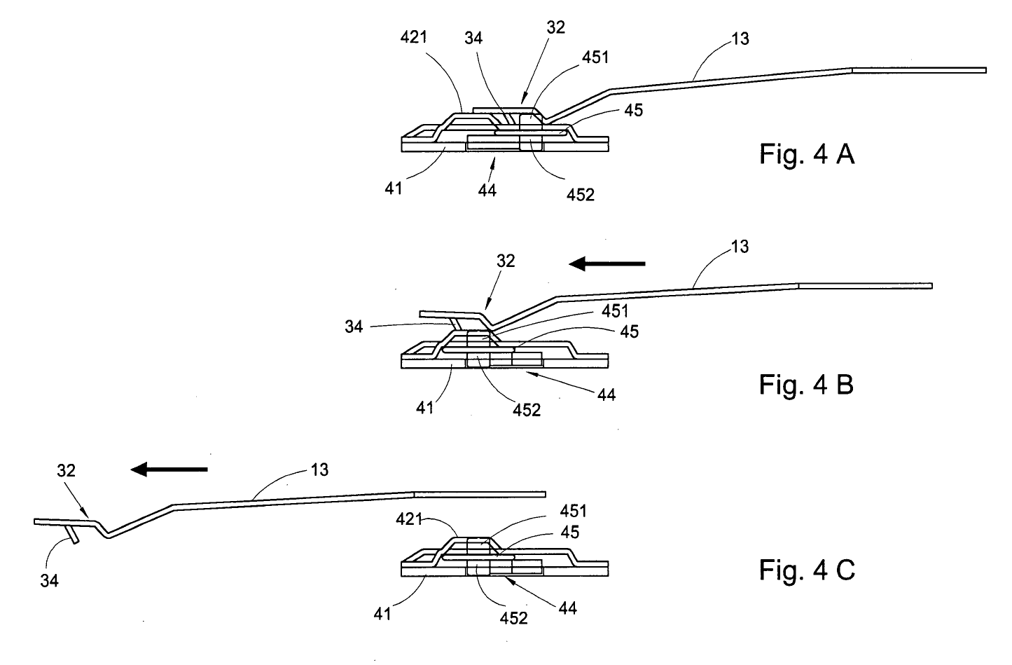

Referring to FIGS. 4B and 4C, when the first connecting section 32 of the first activator 13 drags the third connecting section 451 to the second position, the other end of the first activator 13 is pushed and lifted by the guide face 421, whereby the first connecting section 32 releases the third connecting section 451, permitting the telescopic slide rail set 94 of the second slide rail assembly 12 to be further outward extended.

When the telescopic slide rail set 94 of the second slide rail assembly 12 is pushed into the stationary slide rail 92, the second connecting section 34 of the first activator 13 drags the third connecting section 451 to make the slide member 45 move from the second position to the first position. At this time, the fourth connecting section 452 of the slide member 45 is no more engaged with the bar member 43 and the telescopic slide rail set 94 of the first slide rail assembly 11 can be extended from the front end of the stationary slide rail 92.

According to the above arrangement, the assembled/linked locking apparatus 1 of the present invention has the following advantages:
1. The first and second connecting sections 32, 34 of the first activator 13 can drag the third connecting section 451 of the slide member 45, whereby the slide member 45 can be truly driven to drive the bar member 43.
2. The slide way 44 has a narrower space and a larger space respectively for restricting the slide member 45 from vertically moving and permitting the slide member 45 to vertically move. Therefore, the other drawer can be truly locked or released.

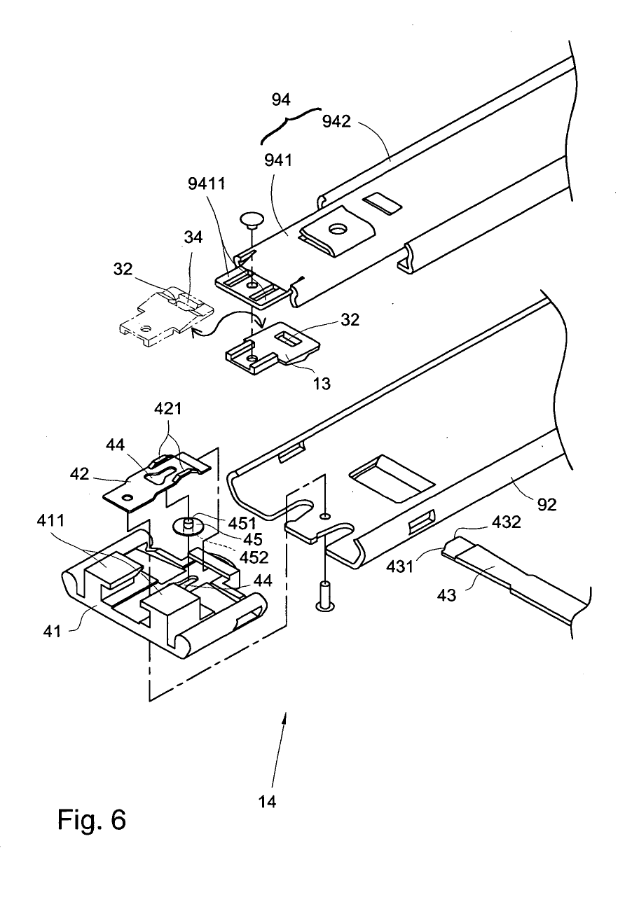

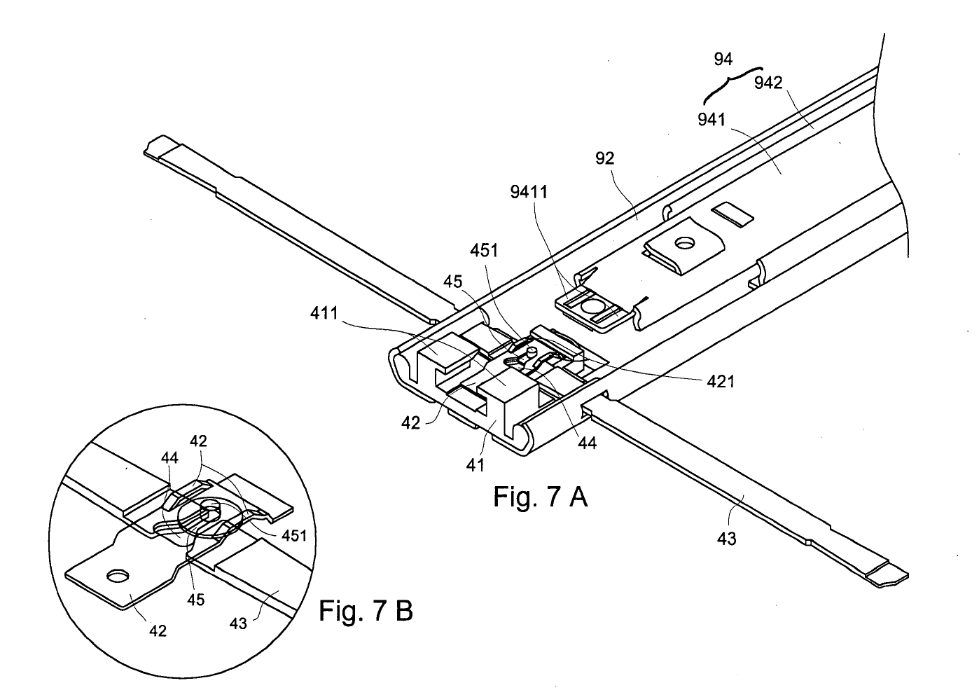

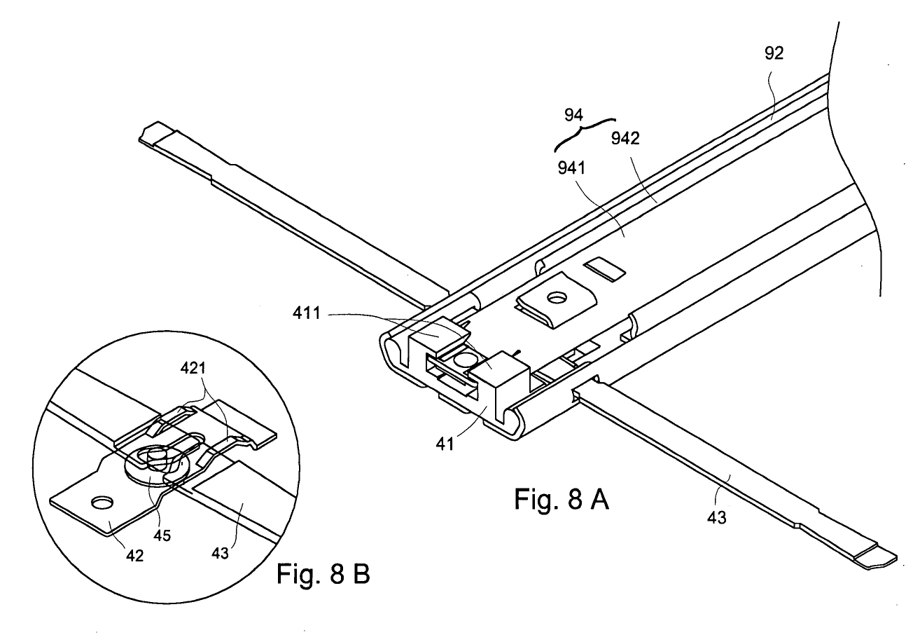

Please refer to FIG. 6, FIG. 7A, FIG. 7B, FIG. 8A and FIG. 8B, in the above structure, wherein the first activator 13 could be disposed at rear end of the drawer slide rail 941. As the second activator 14 is corresponding to the first activator 13, the second activator 14 is disposed at rear end of the stationary slide rail 92. This can achieve the same effect. In addition, the invention further includes a seventh connecting section 9411 and a eighth connecting section 411. The seventh connecting section 9411 is disposed at the rear end of the drawer slide rail 941. The eighth connecting section 411 is disposed at the base seat 41. When the telescopic slide rail set 94 is wholly pushed into the stationary slide rail 92, the seventh connecting section 9411 and the eighth connecting section 411 can mutually abut in order that the slide member 45 can really position at the first position. In case of unexpected external force, the function of the invention is ensured.

Alternatively, each telescopic slide rail set 94 can simply have the drawer slide rail 941 without the middle slide rail 942. Two sidewalls of the drawer slide rail 941 are slidably disposed in the stationary slide rail 92. This can achieve the same effect as the above embodiment.

In addition, a few embodiments of the two slide ways 44 and the end of the bar member 43 of the present invention can be designed as following.

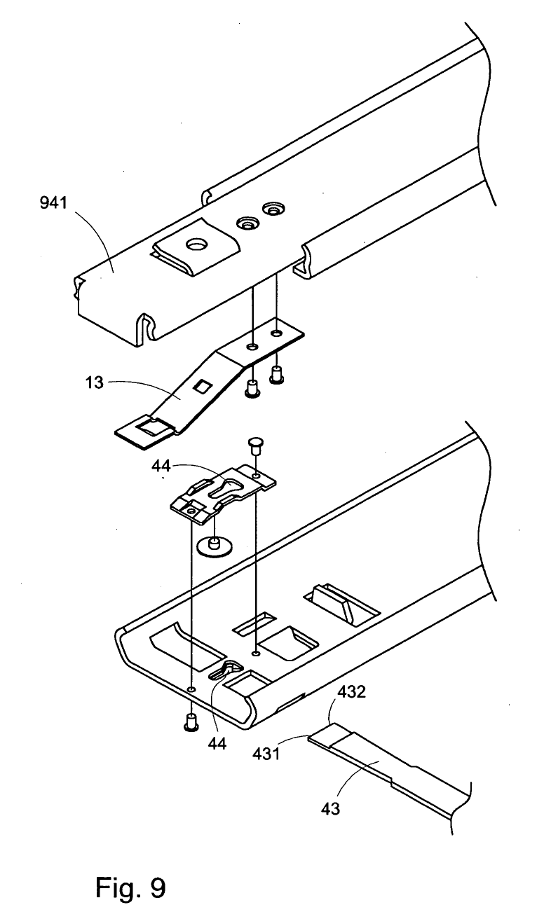

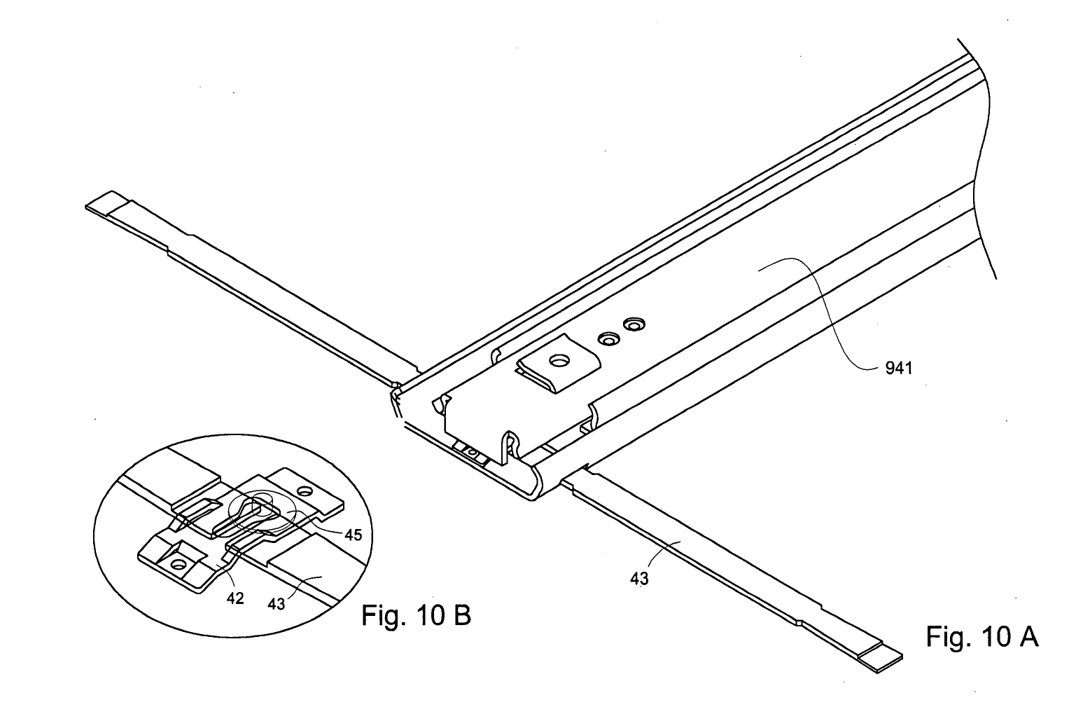

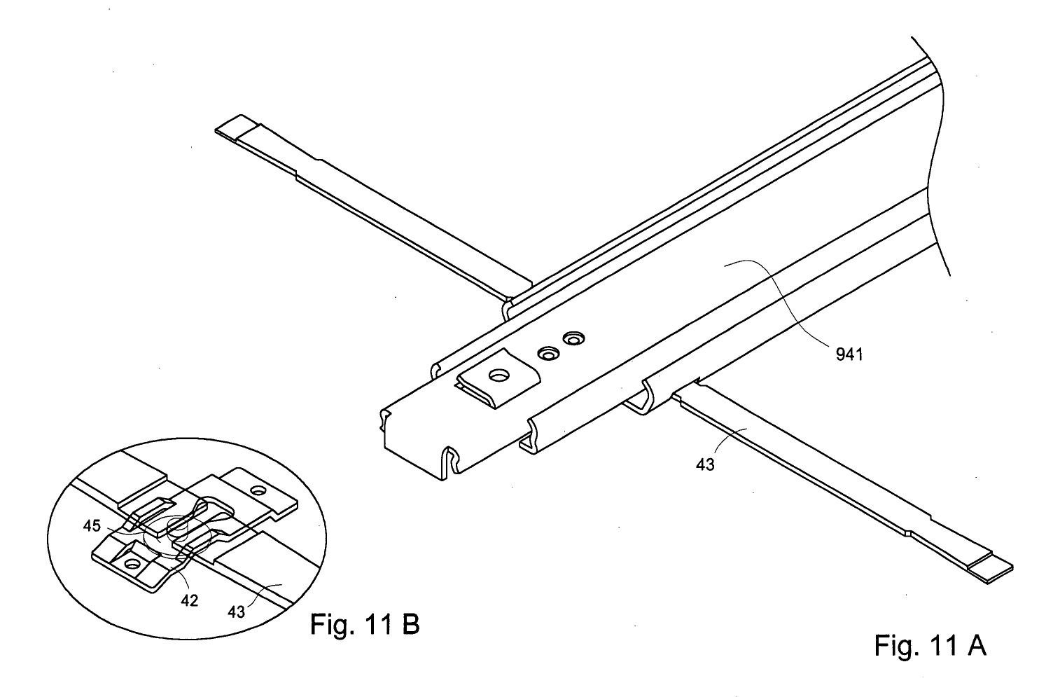

Referring to FIG. 9, FIG. 10A, FIG. 10B, FIG. 11A and FIG. 11B of the first activator 13 being disposed at the front end of the drawer slide rail 941, each slide way 44 is still a perforation having a two-stage shape similar to the shape of a saddle and the fifth connecting section 431 and the sixth connecting section 432 of each end of the bar member 43 are respectively a straight cross section. This can achieve the function of the invention.

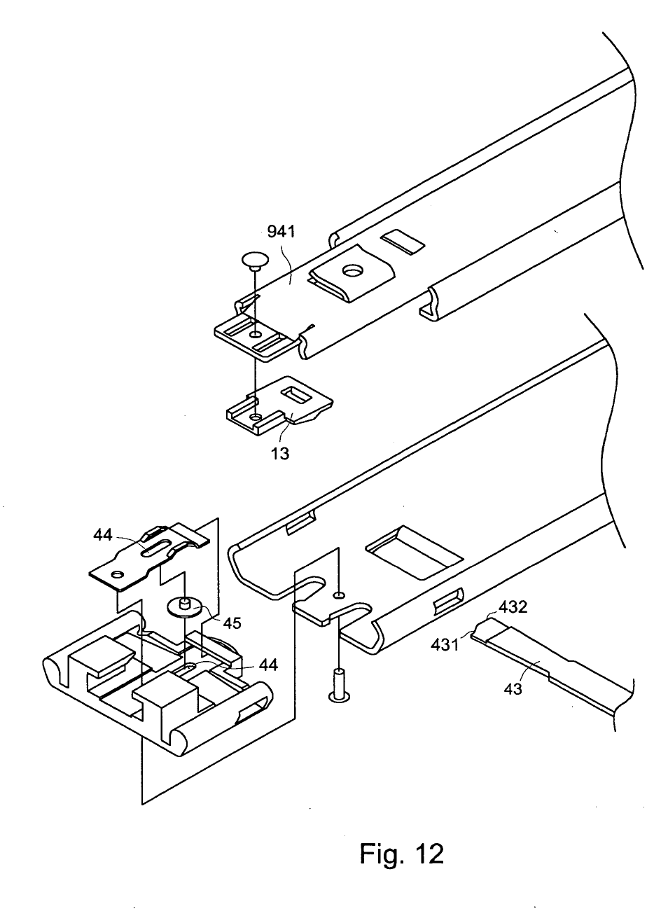

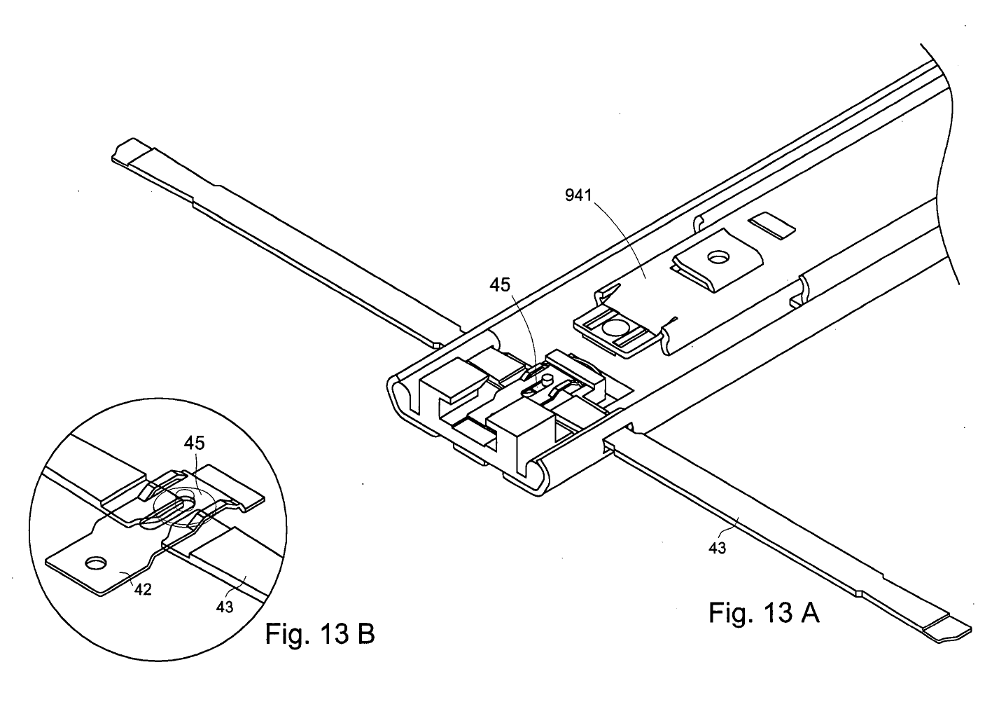

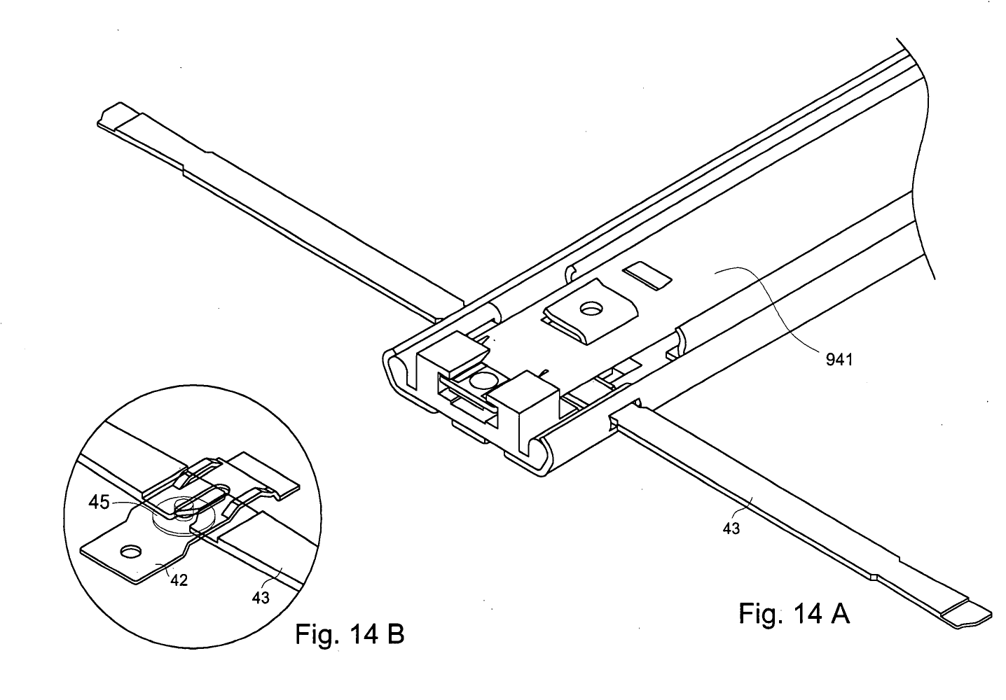

Referring to FIG. 12, FIG. 13A, FIG. 13B, FIG. 14A and FIG. 14B of the first activator 13 being disposed at the rear end of the drawer slide rail 941, each slide way 44 is a perforation without a two-stage shape and the fifth connecting section 431 and the sixth connecting section 432 of each end of the bar member 43 are respectively a notch shape and a straight cross section. Although the slide member 45 only back and forth reciprocally slides between the first position and the second position, the bar member 43 can move under the slide member 45 being at the first position corresponding to the fifth connecting section 431 of the notch. This can achieve the function of the invention.

The above embodiments are only used to illustrate the present invention, not intended to limit the scope thereof. Many modifications of the above embodiments can be made without departing from the spirit of the present invention.

1. An assembled/linked locking apparatus disposed in a cabinet body having at least two vertically arranged drawers, when one of the drawers is drawn out, the other drawer being prevented from extending out of the cabinet body, said locking apparatus comprising:
a first and a second slide rail assemblies being respectively corresponding to each drawer, the first slide rail assembly being positioned above the second slide rail assembly corresponding to the second slide rail assembly, the first slide rail assembly and the second slide rail assembly respectively including a stationary slide rail and a telescopic slide rail set, the stationary slide rail being disposed on the cabinet body, the telescopic slide rail set being disposed on the drawer, the telescopic slide rail set being back and forth slidably disposed in the stationary slide rail, the telescopic slide rail set being extensible out of front end of the stationary slide rail;
a first and a second activators respectively being disposed on the first and second slide rail assemblies, one end of the first activator being disposed at the telescopic slide rail set, the second activator being corresponding to the first activator and disposed at the stationary slide rail, the second activator including a base seat, a guide seat, a bar member, a pair of slide ways and a slide member, the base seat being disposed at the stationary slide rail, the guide seat being disposed on the base seat, the guide seat having a guide face for guiding the other end of the first activator to swing, the bar member being reciprocally movably disposed between the first and second slide rail assemblies, two ends of the bar member being respectively passed through spaces between the base seats and the guide seats of the first and second slide rail assemblies, the two slide ways being oppositely respectively formed on the base seat and the guide seat, the slide member being corresponding to an end of the bar member and being disposed between the base seat and the guide seat, two ends of the slide member being respectively fitted through the slide ways, whereby the slide member can reciprocally move along the slide ways, one end of the slide member being dragged by the first activator and released by the swinging of the first activator, whereby the slide member can be back and forth reciprocally slid between a first position and a second position, whereby when the slide member is positioned in the second position, the slide ways prevent the slide member from moving up and down and the slide member abuts against the bar member, when the slide members of the first and second slide rail assemblies are positioned in the first position, any slide member serving to make the bar member move up and down and when one of the telescopic slide rail set is extended, the first activator drags the slide member from the first position to the second position, whereby the slide member pushes the bar member and then the slide member is engaged with the bar member to prevent the bar member from sliding.

2. The assembled/linked locking apparatus as claimed in claim 1, wherein the first activator is disposed at front end of the telescopic slide rail set.

3. The assembled/linked locking apparatus as claimed in claim 1, wherein the first activator is disposed at rear end of the telescopic slide rail set.

4. The assembled/linked locking apparatus as claimed in claim 2, wherein the telescopic slide rail set includes a drawer slide rail.

5. The assembled/linked locking apparatus as claimed in claim 3, wherein the telescopic slide rail set includes a drawer slide rail.

6. The assembled/linked locking apparatus as claimed in claim 4, wherein:
the telescopic slide rail set further includes a middle slide rail being back and forth slidably disposed in the stationary slide rail; and
the drawer slide rail is disposed on the corresponding drawer and slidably disposed in the middle slide rail.

7. The assembled/linked locking apparatus as claimed in claim 5, wherein:
the telescopic slide rail set further includes a middle slide rail being back and forth slidably disposed in the stationary slide rail; and
the drawer slide rail is disposed on the corresponding drawer and slidably disposed in the middle slide rail.

8. The assembled/linked locking apparatus as claimed in claim 1, wherein:
the first activator is formed with a first connecting section and a second connecting section corresponding to the slide member;
each slide way is a perforation having a two-stage shape similar to the shape of a saddle, the two-stage shape including a narrower space and a larger space;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, the fourth and fifth connecting sections abutting against and pushing each other; and
the bar member is further formed with a sixth connecting section corresponding to the fourth connecting section, when the slide member is positioned in the second position, the fourth connecting section and the sixth connecting section abutting against each other.

9. The assembled/linked locking apparatus as claimed in claim 2, wherein:
the first activator is formed with a first connecting section and a second connecting section corresponding to the slide member;
each slide way is a perforation having a two-stage shape similar to the shape of a saddle, the two-stage shape including a narrower space and a larger space;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, the fourth and fifth connecting sections abutting against and pushing each other; and
the bar member is further formed with a sixth connecting section corresponding to the fourth connecting section, when the slide member is positioned in the second position, the fourth connecting section and the sixth connecting section abutting against each other.

10. The assembled/linked locking apparatus as claimed in claim 3, wherein:
the first activator is formed with a first connecting section and a second connecting section corresponding to the slide member;
each slide way is a perforation having a two-stage shape similar to the shape of a saddle, the two-stage shape including a narrower space and a larger space;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, the fourth and fifth connecting sections abutting against and pushing each other; and
the bar member is further formed with a sixth connecting section corresponding to the fourth connecting section, when the slide member is positioned in the second position, the fourth connecting section and the sixth connecting section abutting against each other.

11. The assembled/linked locking apparatus as claimed in claim 4, wherein:
the first activator is formed with a first connecting section and a second connecting section corresponding to the slide member;
each slide way is a perforation having a two-stage shape similar to the shape of a saddle, the two-stage shape including a narrower space and a larger space;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, the fourth and fifth connecting sections abutting against and pushing each other; and
the bar member is further formed with a sixth connecting section corresponding to the fourth connecting section, when the slide member is positioned in the second position, the fourth connecting section and the sixth connecting section abutting against each other.

12. The assembled/linked locking apparatus as claimed in claim 5, wherein:
the first activator is formed with a first connecting section and a second connecting section corresponding to the slide member;
each slide way is a perforation having a two-stage shape similar to the shape of a saddle, the two-stage shape including a narrower space and a larger space;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, the fourth and fifth connecting sections abutting against and pushing each other; and
the bar member is further formed with a sixth connecting section corresponding to the fourth connecting section, when the slide member is positioned in the second position, the fourth connecting section and the sixth connecting section abutting against each other.

13. The assembled/linked locking apparatus as claimed in claim 6, wherein:
the first activator is formed with a first connecting section and a second connecting section corresponding to the slide member;
each slide way is a perforation having a two-stage shape similar to the shape of a saddle, the two-stage shape including a narrower space and a larger space;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, the fourth and fifth connecting sections abutting against and pushing each other; and
the bar member is further formed with a sixth connecting section corresponding to the fourth connecting section, when the slide member is positioned in the second position, the fourth connecting section and the sixth connecting section abutting against each other.

14. The assembled/linked locking apparatus as claimed in claim 7, wherein:
the first activator is formed with a first connecting section and a second connecting section corresponding to the slide member;
each slide way is a perforation having a two-stage shape similar to the shape of a saddle, the two-stage shape including a narrower space and a larger space;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, the fourth and fifth connecting sections abutting against and pushing each other; and
the bar member is further formed with a sixth connecting section corresponding to the fourth connecting section, when the slide member is positioned in the second position, the fourth connecting section and the sixth connecting section abutting against each other.

15. The assembled/linked locking apparatus as claimed in claim 8, wherein:
the first connecting section is a cross section;
the second connecting section is a lug;
the third and fourth connecting sections are boss-shaped bodies;
the fifth connecting section is a notch; and
the sixth connecting section is a cross section.

16. The assembled/linked locking apparatus as claimed in claim 9, wherein:
the first connecting section is a cross section;
the second connecting section is a lug;
the third and fourth connecting sections are boss-shaped bodies;
the fifth connecting section is a notch; and
the sixth connecting section is a cross section.

17. The assembled/linked locking apparatus as claimed in claim 10, wherein:
the first connecting section is a cross section;
the second connecting section is a lug;
the third and fourth connecting sections are boss-shaped bodies;
the fifth connecting section is a notch; and
the sixth connecting section is a cross section.

18. The assembled/linked locking apparatus as claimed in claim 11, wherein:
the first connecting section is a cross section;
the second connecting section is a lug;
the third and fourth connecting sections are boss-shaped bodies;
the fifth connecting section is a notch; and
the sixth connecting section is a cross section.

19. The assembled/linked locking apparatus as claimed in claim 12, wherein:
the first connecting section is a cross section;
the second connecting section is a lug;
the third and fourth connecting sections are boss-shaped bodies;
the fifth connecting section is a notch; and
the sixth connecting section is a cross section.

20. The assembled/linked locking apparatus as claimed in claim 13, wherein:
the first connecting section is a cross section;
the second connecting section is a lug; the third and fourth connecting sections are boss-shaped bodies;
the fifth connecting section is a notch; and
the sixth connecting section is a cross section.

21. The assembled/linked locking apparatus as claimed in claim 14, wherein:
the first connecting section is a cross section;
the second connecting section is a lug;
the third and fourth connecting sections are boss-shaped bodies;
the fifth connecting section is a notch; and
the sixth connecting section is a cross section.

22. The assembled/linked locking apparatus as claimed in claim 10, further comprising a seventh connecting section and a eighth connecting section, the seventh connecting section being disposed at the rear end of the telescopic slide rail set, the eighth connecting section being disposed at the base seat, whereby when the telescopic slide rail set is wholly pushed into the stationary slide rail, the seventh connecting section and the eighth connecting section can mutually abut in order that the slide member can really position at the first position.

23. The assembled/linked locking apparatus as claimed in claim 12, further comprising a seventh connecting section and a eighth connecting section, the seventh connecting section being disposed at the rear end of the drawer slide rail, the eighth connecting section being disposed at the base seat, whereby when the telescopic slide rail set is wholly pushed into the stationary slide rail, the seventh connecting section and the eighth connecting section can mutually abut in order that the slide member can really position at the first position.

24. The assembled/linked locking apparatus as claimed in claim 14, further comprising a seventh connecting section and a eighth connecting section, the seventh connecting section being disposed at the rear end of the drawer slide rail, the eighth connecting section being disposed at the base seat, whereby when the telescopic slide rail set is wholly pushed into the stationary slide rail, the seventh connecting section and the eighth connecting section can mutually abut in order that the slide member can really position at the first position.

25. The assembled/linked locking apparatus as claimed in claim 8, wherein:
the first connecting section is a cross section;
the second connecting section is a lug;
the third and fourth connecting sections are boss-shaped bodies;
the fifth connecting section is a cross section; and
the sixth connecting section is a cross section.

26. The assembled/linked locking apparatus as claimed in claim 9, wherein:
the first connecting section is a cross section;
the second connecting section is a lug;
the third and fourth connecting sections are boss-shaped bodies;
the fifth connecting section is a cross section; and
the sixth connecting section is a cross section.

27. The assembled/linked locking apparatus as claimed in claim 10, wherein:
the first connecting section is a cross section;
the second connecting section is a lug;
the third and fourth connecting sections are boss-shaped bodies;
the fifth connecting section is a cross section; and
the sixth connecting section is a cross section.

28. The assembled/linked locking apparatus as claimed in claim 11, wherein:
the first connecting section is a cross section;
the second connecting section is a lug;
the third and fourth connecting sections are boss-shaped bodies;
the fifth connecting section is a cross section; and
the sixth connecting section is a cross section.

29. The assembled/linked locking apparatus as claimed in claim 12, wherein:
the first connecting section is a cross section;
the second connecting section is a lug;
the third and fourth connecting sections are boss-shaped bodies;
the fifth connecting section is a cross section; and
the sixth connecting section is a cross section.

30. The assembled/linked locking apparatus as claimed in claim 13, wherein:
the first connecting section is a cross section;
the second connecting section is a lug;
the third and fourth connecting sections are boss-shaped bodies;
the fifth connecting section is a cross section; and
the sixth connecting section is a cross section.

31. The assembled/linked locking apparatus as claimed in claim 14, wherein:
the first connecting section is a cross section;
the second connecting section is a lug;
the third and fourth connecting sections are boss-shaped bodies;
the fifth connecting section is a cross section; and
the sixth connecting section is a cross section.

32. The assembled/linked locking apparatus as claimed in claim 1, wherein:
the first activator is formed with a first connecting section and a second connecting section corresponding to the slide member;
each slide way is a perforation;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, means of the fourth and fifth connecting sections for relatively moving of the bar member and the slide member; and
the bar member is further formed with a sixth connecting section corresponding to the fourth connecting section, when the slide member is positioned in the second position, the fourth connecting section and the sixth connecting section abutting against each other.

33. The assembled/linked locking apparatus as claimed in claim 2, wherein:
the first activator is formed with a first connecting section and a second connecting section corresponding to the slide member;
each slide way is a perforation;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, means of the fourth and fifth connecting sections for relatively moving of the bar member and the slide member; and
the bar member is further formed with a sixth connecting section corresponding to the fourth connecting section, when the slide member is positioned in the second position, the fourth connecting section and the sixth connecting section abutting against each other.

34. The assembled/linked locking apparatus as claimed in claim 3, wherein:
the first activator is formed with a first connecting section and a second connecting section corresponding to the slide member;
each slide way is a perforation;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, means of the fourth and fifth connecting sections for relatively moving of the bar member and the slide member; and
the bar member is further formed with a sixth connecting section corresponding to the fourth connecting section, when the slide member is positioned in the second position, the fourth connecting section and the sixth connecting section abutting against each other.

35. The assembled/linked locking apparatus as claimed in claim 4, wherein:
the first activator is formed with a first connecting section and a second connecting section corresponding to the slide member;
each slide way is a perforation;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, means of the fourth and fifth connecting sections for relatively moving of the bar member and the slide member; and
the bar member is further formed with a sixth connecting section corresponding to the fourth connecting section, when the slide member is positioned in the second position, the fourth connecting section and the sixth connecting section abutting against each other.

36. The assembled/linked locking apparatus as claimed in claim 5, wherein:
the first activator is formed with a first connecting section and a second connecting section corresponding to the slide member;
each slide way is a perforation;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, means of the fourth and fifth connecting sections for relatively moving of the bar member and the slide member; and
the bar member is further formed with a sixth connecting section corresponding to the fourth connecting section, when the slide member is positioned in the second position, the fourth connecting section and the sixth connecting section abutting against each other.

37. The assembled/linked locking apparatus as claimed in claim 6, wherein:
the first activator is formed with a first connecting section and a second connecting section corresponding to the slide member;
each slide way is a perforation;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, means of the fourth and fifth connecting sections for relatively moving of the bar member and the slide member; and
the bar member is further formed with a sixth connecting section corresponding to the fourth connecting section, when the slide member is positioned in the second position, the fourth connecting section and the sixth connecting section abutting against each other.

38. The assembled/linked locking apparatus as claimed in claim 7, wherein:
the first activator is formed with a first connecting section and a second connecting section corresponding to the slide member;
each slide way is a perforation;
one side of the slide member is formed with a third connecting section corresponding to the first and second connecting sections, the first connecting section serving to connect with the third connecting section and drag the slide member from the first position to the second position, the second connecting section serving to connect with the third connecting section and drag the slide member from the second position to the first position;
a fourth connecting section is formed on the other side of the slide member opposite to the third connecting section, the bar member being formed with a fifth connecting section corresponding to the fourth connecting section, when the slide member is positioned in the first position, means of the fourth and fifth connecting sections for relatively moving of the bar member and the slide member; and
the bar member is further formed with a sixth connecting section corresponding to the fourth connecting section, when the slide member is positioned in the second position, the fourth connecting section and the sixth connecting section abutting against each other.

39. The assembled/linked locking apparatus as claimed in claim 32, wherein:
the first connecting section is a cross section;
the second connecting section is a lug;
the third and fourth connecting sections are boss-shaped bodies;
the fifth connecting section is a notch; and
the sixth connecting section is a cross section.

40. The assembled/linked locking apparatus as claimed in claim 33, wherein:
the first connecting section is a cross section;
the second connecting section is a lug;
the third and fourth connecting sections are boss-shaped bodies;
the fifth connecting section is a notch; and
the sixth connecting section is a cross section.

41. The assembled/linked locking apparatus as claimed in claim 34, wherein:
the first connecting section is a cross section;
the second connecting section is a lug;
the third and fourth connecting sections are boss-shaped bodies;
the fifth connecting section is a notch; and
the sixth connecting section is a cross section.

42. The assembled/linked locking apparatus as claimed in claim 35, wherein:
the first connecting section is a cross section;
the second connecting section is a lug;
the third and fourth connecting sections are boss-shaped bodies;
the fifth connecting section is a notch; and
the sixth connecting section is a cross section.

43. The assembled/linked locking apparatus as claimed in claim 36, wherein:
the first connecting section is a cross section;
the second connecting section is a lug;
the third and fourth connecting sections are boss-shaped bodies;
the fifth connecting section is a notch; and
the sixth connecting section is a cross section.

44. The assembled/linked locking apparatus as claimed in claim 37, wherein:
the first connecting section is a cross section;
the second connecting section is a lug;
the third and fourth connecting sections are boss-shaped bodies;
the fifth connecting section is a notch; and
the sixth connecting section is a cross section.

45. The assembled/linked locking apparatus as claimed in claim 38, wherein:
the first connecting section is a cross section;
the second connecting section is a lug;
the third and fourth connecting sections are boss-shaped bodies;
the fifth connecting section is a notch; and
the sixth connecting section is a cross section.
